(19) United States
(12) Patent Application Publication
(10) Pub. No.: US 2025/0139331 A1
(43) Pub. Date: May 1, 2025

(54) TARGETED PERCEPTION-ORIENTED TWIN SUBSTRUCTURE INTERACTION METHOD AND SYSTEM, AND APPLICATION

(71) Applicant: Southeast University, Jiangsu (CN)

(72) Inventors: Jian Zhang, Jiangsu (CN); Yixuan Chen, Jiangsu (CN); Feiyu Wang, Jiangsu (CN); Chenhao Gao, Jiangsu (CN)

(73) Assignee: Southeast University, Jiangsu (CN)

(21) Appl. No.: 18/576,376

(22) PCT Filed: Nov. 6, 2023
(86) PCT No.: PCT/CN2023/129879

§ 371 Date: Jan. 4, 2024

(30) Foreign Application Priority Data
Nov. 1, 2023 (CN) 202311437153.8

(51) Int. Cl. G06F 30/23; G01M 5/00; G06F 111/10; G06F 119/14

(52) U.S. Cl. CPC G06F 30/23; G01M 5/0033; G06F 2111/10; G06F 2119/14

(57) ABSTRACT

The present invention relates to a targeted perception-oriented twin substructure interaction method and system, and application. The method includes: acquiring multivariate inspection and monitoring data and finite element influence line data of a main structure; solving, on the basis of the inspection and monitoring data and the finite element influence line data of a non-focus region, boundary conditions of a focus region; establishing, for the focus region, a refined twin substructure finite element model, and correcting material properties of the refined twin substructure finite element model on the basis of the inspection and monitoring data and the finite element influence line data of the focus region; and calculating a correction force on the basis of the boundary conditions of the focus region and the material properties, and using the correction force as an equivalent external load to act on nodes of a global finite element model.

### TECHNICAL FIELD

The present invention relates to the field of structural safety evaluation and the technical field of data processing, in particular to a targeted perception-oriented twin substructure interaction method and system, and application.

### DESCRIPTION OF RELATED ART

Bridge structural health monitoring and inspection technology may provide timely and effective structural disease information, and many scholars have carried out a large number of studies on direct inversion of structural state based on inspection and monitoring data. However, for structures with large size and complex stress state, it is difficult to analyze and evaluate the structural service performance by simply using the structural inspection and monitoring data. The rapid development of finite element theory has facilitated the bridge structural analysis, and a finite element lifting method based on monitoring data has been widely studied. However, existing methods still have the following problems.

(1) It is difficult to fully integrate structural internal and external damages in a focus region on the basis of existing methods such as finite element model lifting, and it is difficult to fully integrate inspection and monitoring data to carry out structural analysis and evaluation.

(2) An actual structure is large in size and complex in stress state, and if refined analysis is carried out on the whole structure, the analysis efficiency may be low. Therefore, if bridge inspection and monitoring information may be fully utilized in the simulation and analysis process, it is expected to break through the bottleneck of bridge structural state analysis and evaluation through the combination of structural mechanical model analysis (forward evolution) and inspection and monitoring information fusion (inverse evolution).

Finite element model updating has been widely studied and applied in the field of civil engineering, and is one of the effective ways to integrate monitoring data with a finite element model. However, the finite element model updating technology is mainly to update internal parameters of the model to achieve coincidence of theoretical values with monitoring values of measurement points, and the updated parameters of the finite element model tend to reflect the overall structural properties, which is insufficient for the application and mining of monitoring data. In contrast, a hybrid simulation method in the field of earthquake engineering achieves synchronous coupling of numerical substructure analysis calculation and experimental substructure dynamic loading through interactive technology, which truly realizes the deep integration of experimental and numerical analysis. Inspired by hybrid simulation, the concept of hybrid monitoring is proposed in the field of structural health, which combines bridge monitoring data with the finite element model to achieve rapid reconstruction of structural responses.

It is more suitable to meet the needs of a bridge structural health system and structural safety evaluation to carry out refined analysis on important portions by fusing inspection and monitoring data. In the existing structural health monitoring system, sensor arrangement follows the principle of economic rationality. Typically, more sensors are arranged in a structural focus region, such as a region with large structural stress, large deformation or diseases, while fewer sensors are arranged in structural non-focus regions.

However, most of the existing methods do not consider the interaction between a global model and a local model, and there is still a bottleneck problem that the inspection and monitoring data and the finite element model are difficult to integrate with each other.

In summary, existing structural finite element analysis methods used in the structural safety evaluation process have a very limited degree of integration of inspection and monitoring data, and there are problems such as inaccurate structural evaluation when carrying out structural analysis and evaluation on existing structures with large size and complex stress state.

### SUMMARY OF INVENTION

In order to overcome the above-mentioned defects in the prior art, the present invention provides a targeted perception-oriented twin substructure interaction method and system, and application, so as to overcome, or partially overcome, the bottleneck problem that inspection and monitoring data and a finite element model are difficult to integrate.

The objective of the present invention may be implemented through the following technical solutions.

In one aspect of the present invention, a targeted perception-oriented twin substructure interaction method is provided. The method includes the following steps:
acquiring multivariate inspection and monitoring data and finite element influence line data of a main structure, wherein the main structure is divided into a focus region and a non-focus region;
solving, on the basis of the inspection and monitoring data and the finite element influence line data of the non-focus region, boundary conditions of the focus region using an adaptive sparsity matching tracking algorithm to achieve a first level of data fusion;
establishing, for the focus region, a refined twin substructure finite element model considering a structural deterioration influence, and correcting material properties of the refined twin substructure finite element model on the basis of the inspection and monitoring data and the finite element influence line data of the focus region to achieve a second level of data fusion; and
calculating a correction force on the basis of the boundary conditions of the focus region and the material properties, and using the correction force as an equivalent external load to act on nodes of a global finite element model, to complete interaction between the refined twin substructure finite element model and the global finite element model.

As the preferred technical solution, the process of solving boundary conditions of the focus region includes:
establishing a mathematical equation for inspection data and the finite element influence line data of the non-focus region; and
transforming the mathematical equation into an NP-hard non-convex combinational optimization problem to be solved using the adaptive sparsity matching tracking algorithm.

As the preferred technical solution, the adaptive sparsity matching tracking algorithm includes the following steps:
constructing an influence line matrix on the basis of the finite element influence line data, performing singular value decomposition, and projecting the multivariate inspection and monitoring data onto a subspace spanned by column vectors of the influence line matrix; and
on the basis of the projection of the multivariate inspection and monitoring data onto the subspace spanned by the column vectors of the influence line matrix, changing sparsity of an item to be solved by iterative computation, and taking sparsity with the highest solving accuracy after repeated iterations as the sparsity of the item to be solved.

As the preferred technical solution, the adaptive sparsity matching tracking algorithm specifically includes:
Step 1, inputting the influence line matrix A and the monitoring data Y;
Step 2, performing singular value decomposition on the influence line matrix, and projecting the monitoring data Y onto the subspace spanned by the column vectors of the influence line matrix A, i.e., y=Proj_{A}(Y);
Step 3, initializing r₀=y, Λ₀=ϕ, and t=1;
Step 4, calculating a correlation coefficient u=abs [A^{T}rₜ₋₁], selecting 2K maximum values in u, and forming a column ordinal set J₀ by the maximum values corresponding to a column ordinal j of A;
Step 5, enabling Λₜ=Λₜ₋₁∪J₀ and Aₜ=Aₜ₋₁∪aⱼ(j∈J₀);
Step 6, calculating \hat{θ}ₜ=argmin_{θt}∥y−Aₜθₜ∥=(Aₜ^{T}Aₜ)⁻¹Aₜ^{T}y;
Step 7, \hat{θ}ₜₖ=max(abs(\hat{θ}ₜ)), denoting K items corresponding to Aₜ as A_{tK}, denoting a column ordinal corresponding to A as Λ_{tK}, and updating a set Λₜ=Λ_{tK};
Step 8, calculating and updating an error rₜ=y−A_{tK}\hat{θ}ₜₖ=y−A_{tK}(A_{tK}^{T}A_{tK})⁻¹A_{tK}^{T}y;
Step 9, t=t+1, if t≤2K, returning to Step 2 to continue an iteration, otherwise, proceeding to Step 10;
Step 10, updating the sparsity K=K+ceil(0.02*size(A, 2)); and
Step 11, if the sparsity exceeds K=size(A,2)*0.5 or the error is less than a preset threshold, outputting an equivalent node force F=θ\hat{ }_tK as the boundary conditions of the focus region, otherwise, performing Step 4,
wherein t denotes the number of iterations, Ø denotes an empty set, J₀ denotes an index obtained from each iteration, ∧ₜ denotes an index set of a t-th iteration, the number of elements of ∧ₜ is Lₜ, aⱼ denotes a j-th column of the influence line matrix A, Aₜ={aⱼ}(j∈θₜ) denotes a column set of the influence line matrix A selected according to the index set ∧ₜ, θₜ denotes a column vector of Lₜ×1, and a notation U denotes a set and operation.

As the preferred technical solution, the structural deterioration influence includes an external crack disease influence and an internal corrosion disease influence.

As the preferred technical solution, the process of constructing a refined twin substructure finite element model considering a structural deterioration influence includes:
establishing a first reduction relationship between an external crack width of the main structure and stiffness of an avianized element using a crack avianized element method to achieve modeling of the external crack disease influence;
establishing a second reduction relationship between an internal steel reinforcement corrosion rate of the main structure and a structural deterioration constitution on the basis of material parameters inside a steel reinforcement corrosion deterioration constitution to achieve modeling of the internal corrosion disease influence; and
constructing the refined twin substructure finite element model on the basis of the first reduction relationship and the second reduction relationship.

As the preferred technical solution, the focus region is a multi-disease region found during inspection or a vulnerable region of mechanical analysis, and the non-focus region is a portion of the main structure other than the focus region.

As the preferred technical solution, the multivariate inspection and monitoring data includes a node displacement value, a node corner value and a strain displacement value, and the material properties include at least one of a concrete constitutive parameter, a steel reinforcement constitutive parameter, and a steel constitutive parameter.

In another aspect of the present invention, application of the targeted perception-oriented twin substructure interaction method described above is provided. The application includes the following steps:
completing interaction between a refined twin substructure finite element model and a global finite element model using the targeted perception-oriented twin substructure interaction method;
calculating a theoretical displacement of a node using the global finite element model subjected to interaction;
acquiring a measured displacement of the node; and
performing a safety evaluation on a load carrying capacity of the main structure on the basis of the theoretical displacement and the measured displacement.

In another aspect of the present invention, a targeted perception-oriented twin substructure interaction system is provided. The system includes
a finite element information extraction module configured to acquire finite element influence line data;
a boundary condition solving module configured to solve a boundary conditions of a focus region by means of a preset storage medium on the basis of finite element influence line data of a non-focus region of a main structure and obtained multivariate inspection and monitoring data, wherein the storage medium includes an instruction for implementing an adaptive sparsity matching tracking algorithm;
a twin substructure refined identification module configured to establish, for the focus region of the main structure, a refined twin substructure finite element model considering a structural deterioration influence; and
a correction feedback module configured to correct material properties of the refined twin substructure finite element model on the basis of the inspection and monitoring data and the finite element influence line data of the focus region, calculate a correction force on the basis of the boundary conditions of the focus region and the material properties, and use the correction force as an equivalent external load to act on nodes of a global finite element model.

Compared with the prior art, the present invention has the following beneficial effects.

(1) The effective mutual integration of the inspection and monitoring data and the finite element model is achieved: In order to solve the bottleneck problem that the inspection and monitoring data and the finite element model are difficult to integrate with each other, the present application achieves the first level of fusion of the inspection and monitoring data and the finite element model by solving the boundary conditions of the focus region on the basis of the inspection and monitoring data and the finite element influence line data of the non-focus regions and using the adaptive sparsity matching tracking algorithm, and achieves the second level of fusion between the inspection and monitoring data and the finite element model by correcting the material properties of the refined twin substructure finite element model on the basis of the inspection and monitoring data and the finite element influence line data of the focus region. Through the two-level interaction, information integration and interaction between the global model and the local model of the focus region requiring refined identification are achieved, the modeling and analysis accuracy of the finite element model of the structural focus portion is effectively improved, and the present invention can be widely used in safety evaluation and other application scenarios.

(2) The boundary conditions of the focus region are solved conveniently: In order to solve the problem that for some structures, it is difficult to arrange sensors on the boundary of the focus region to measure boundary physical condition values thereof, the present invention establishes the mathematical equation of the intrinsic connection between the monitoring data of the non-focus regions and the finite element influence line, and achieves a high-accuracy solution of the boundary conditions of the focus region by means of the adaptive sparsity matching tracking algorithm. The method can effectively solve the boundary conditions of the focus region only with a small amount of monitoring data of the non-focus regions, thereby solving the problem that it is difficult to arrange sensors on the boundary of a complex structure and the boundary cannot be measured.

(3) The analysis efficiency of a complex structure is improved: In order to solve the problem of low efficiency caused by establishing an overall refined finite element model for a structure with large size and complex stress state to carry out structural analysis, the present invention transforms the time-consuming analysis of establishing a refined model globally considering damages of the overall structure into the nonlinear analysis of the focus region and the equivalent linear elastic analysis of the simplified main structure, which eliminates the need for the establishment of a refined model of the entire structure, can complete structural analysis and evaluation by means of the interaction analysis of the focus region and the main structure, and has the advantages of fast and accurate analysis.

### BRIEF DESCRIPTION OF DRAWINGS

FIG. 1 is a schematic diagram of a targeted perception-oriented substructure interaction method in Embodiment 1.

FIG. 2 is a schematic flow diagram of a refined identification process of a structural focus region of two-level interaction of inspection and monitoring data and a finite element model in Embodiment 1.

FIG. 3 is a schematic diagram of interaction analysis of nonlinear analysis of a substructure and equivalent linear elastic analysis of a main structure in Embodiment 1.

FIG. 4 is a flow diagram of an adaptive sparsity matching tracking algorithm in Embodiment 1.

FIG. 5 is a schematic diagram of an interaction process between a main structure and a substructure in Embodiment 1.

FIG. 6 is a flow diagram of a structural safety evaluation method based on a main structure finite element model in Embodiment 1.

FIG. 7 is a schematic diagram of an analysis calculation system for fusion of inspection and monitoring data and a finite element model in Embodiment 3.

FIG. 8 is an arrangement diagram of experimental apparatuses and sensors in Embodiment 1.

FIG. 9 is a schematic diagram of substructure refined identification of two-level fusion of inspection and monitoring data and a finite element model in Embodiment 1.

FIG. 10 shows structural refined analysis and evaluation results of a focus region in Embodiment 1.

FIG. 11 shows evaluation results of a main structure in Embodiment 1, where (a) is a result of a displacement meter 3, and (b) is a result of a displacement meter 4.

FIG. 12 is an arrangement diagram of an experimental apparatus and sensors in Embodiment 2.

FIG. 13 is a flow diagram of a targeted perception-oriented substructure interaction method in Embodiment 2.

FIG. 14 shows analysis results of a substructure in Embodiment 2, where (a) is a result of Case 1, (b) is a result of Case 2, (c) is a result of Case 3, and (d) is a result of Case 4.

FIG. 15 shows interaction analysis results of a main structure in Embodiment 2, where (a) is a result of Case 1, (b) is a result of Case 2, (c) is a result of Case 3, and (d) is a result of Case 4.

1. Finite Element Information Extraction Module, 2. Mathematical Equation Construction module, 3. Boundary condition solving module, 4. Twin substructure refined identification module, 5. Correction feedback module, 6. Loading apparatus, 7. Camera, 8. Reinforced concrete beam, 9. Displacement meter, and 10. Calibration plate.

### DESCRIPTION OF THE EMBODIMENTS

The technical solutions according to the embodiments of the present invention will be clearly and completely described below with reference to the accompanying drawings in the embodiments of the present invention. Apparently, the described embodiments are a part of the embodiments of the present invention, rather than all the embodiments. All other embodiments derived by a person of ordinary skill in the art from the embodiments of the present invention without any creative effort shall fall within the scope of protection of the present invention.

Part of definitions involved in the present application are as follows.

Focus region and non-focus region: a main structure includes two parts, i.e., the focus region and the non-focus region, where the focus region is a portion that needs focus and refined identification, and is selected according to the specific application scenario.

Substructure and main structure: the main structure is the overall structure of a target building, and the substructure is a structure corresponding to the aforementioned focus region.

Twin substructure finite element model and global model: the twin substructure finite element model is a finite element model established for the aforementioned substructure, and the global model is a finite element model established for the aforementioned main structure, where the twin substructure finite element model is established using a solid unit with higher accuracy compared to the global model, and the finite element model includes a plurality of set nodes.

### Embodiment 1

Aiming at the aforementioned problems in the prior art, this embodiment provides a targeted perception-oriented twin substructure interaction method to achieve accurate analysis of important regions and rapid evaluation of the overall main structure. Firstly, in order to solve the bottleneck problem that inspection and monitoring data and a finite element model are difficult to integrate, two-level fusion of the inspection and monitoring data and the finite element model is achieved by means of techniques such as mathematical equations, mathematical equation solving, and substructure model lifting, thereby achieving refined analysis of structural focus regions. Then, with regard to the problem of low efficiency caused by establishing an overall refined finite element model for a structure with large size and complex stress state to carry out structural analysis, an interaction analysis theory of nonlinear analysis of a substructure and equivalent linear elastic analysis of a main structure is provided.

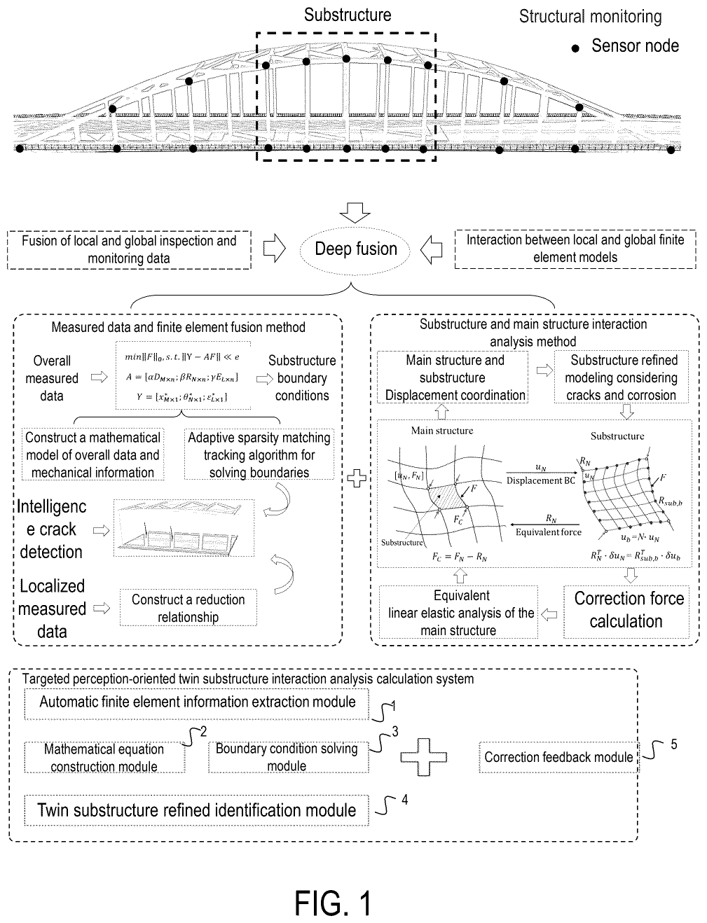

Referring to FIG. 1, the method mainly includes two parts: a measured data and finite element fusion method and a substructure and main structure interaction analysis method, the measured data and finite element fusion method corresponding to steps S1-S7, and the substructure and main structure interaction analysis method corresponding to steps S8-S10.

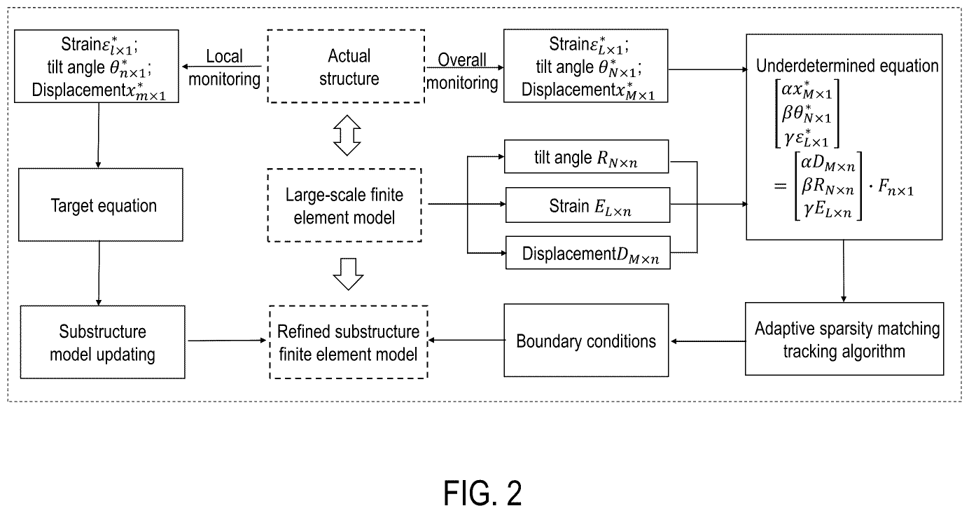

Referring to FIG. 2, the targeted perception-oriented twin substructure interaction method includes the following steps.

Step S1, a main structure to be analyzed is divided into a focus region and a plurality of non-focus regions. The division of the focus region may be based on a multi-disease region found during structural inspection or a vulnerable region (usually the most stressed portion) of mechanical analysis.

Step S2, multivariate inspection and monitoring data and finite element influence line information (i.e., the overall measured data in FIG. 1) of the focus region and the non-focus regions are extracted respectively.

Step S3, a first level of fusion of the inspection and monitoring data of the non-focus regions and a finite element model is performed. Specifically, a mathematical equation of a small amount of monitoring data and the finite element influence line information of the non-focus regions is established, which corresponds to the construction of a mathematical model of the overall data and mechanical information in FIG. 1. This step includes the following substeps:

Step S31, influence line analysis on a simplified global model (i.e., a large-scale finite element model) is carried out to obtain influence lines of physical parameters thereof such as corner, displacement and strain, and construct an influence line matrix W=[D_{n×n}; R_{n×n}; E_{n×n}] thereof, where D_{n×n}, R_{n×n}, and E_{n×n} denote a displacement influence line matrix, a corner influence line matrix, and a strain influence line matrix respectively.

Step S32, a mathematical model of a structural response is established, such as the corner, displacement and strain, the influence line matrix and a load:

$$[ {x}_{n \times 1} ; {θ}_{n \times 1} {ε}_{n \times 1} ] = [ {D}_{n \times n} ; {R}_{n \times n} ; {E}_{n \times n} ] \cdot {F}_{n \times 1} ,$$

where x_{n×1} denotes a node displacement value, θ_{n×1} denotes a node corner value, E_{n×1} denotes a strain displacement value, and F_{n×1} denotes a node load.

Step S33, only row and column data in the above mathematical equation related to the non-focus regions is retained. On this basis, the influence of various monitoring data on a solution of the equation is eliminated by normalization coefficients (α, β and γ denote the normalization coefficients), and the mathematical equation for the fusion of the monitoring data of the non-focus regions and the finite element model is finally established:

$$[ {x}_{M \times 1}^{*} ; {θ}_{N \times 1}^{*} ; {ε}_{L \times 1}^{*} ] = [ α {D}_{M \times n} ; β {R}_{N \times n} ; γ {E}_{L \times n} ] \cdot {F}_{n \times 1} ,$$

where x_{M×1}* denotes M displacement monitoring data of the structural non-focus regions, θ_{N×1}* denotes N corner monitoring data of the structural non-focus regions, and ε_{L×1}* denotes L strain monitoring data of the structural non-focus regions.

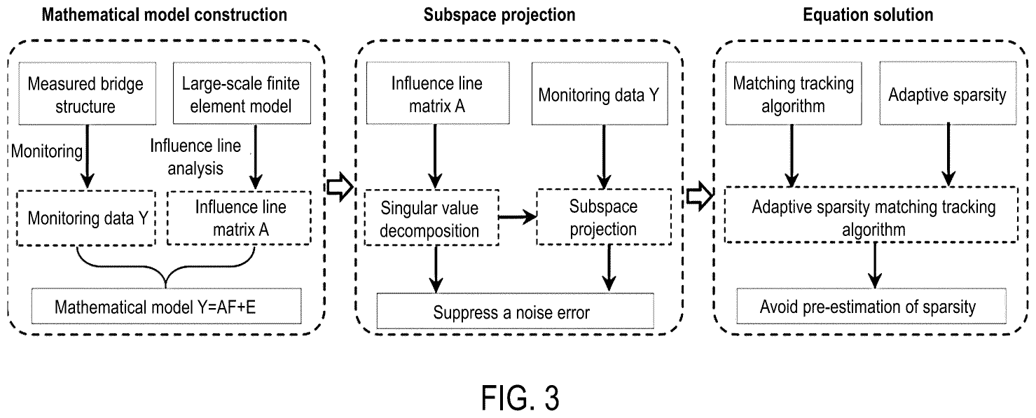

Step S4, as shown in FIG. 3, on the basis of constructing the mathematical equation, the above mathematical equation is transformed into an NP-hard non-convex combinatorial optimization problem by mathematical derivation.

Considering that the solution of the above underdetermined equation usually has a certain error, a minor error term is introduced, and the above mathematical equation is further expressed as: Y=AF+E, where Y=[x_{M×1}*; θ_{N×1}*; ε_{L×1}*], A=[αD_{M×n}; βR_{N×n}; γE_{L×n}], and E denotes the minor error term of the solution of the underdetermined equation.

Singular value decomposition is performed on the influence line matrix A, and the decomposition process thereof may be expressed as: A=UΣV^{H}. By means of the singular value decomposition, the (M+N+L)*n matrix A is decomposed into an (M+N+L)*(M+N+L) unitary matrix U, an (M+N+L)*n diagonal matrix Σ, and a conjugate transpose matrix V^{H} of an n*n unitary matrix V.

The multivariate monitoring data Y is projected onto a subspace span (A) spanned by column vectors of the influence line matrix A. The projection process may be expressed as:

$${Proj}_{A} ( Y ) = {U ( {U}^{H} U )}^{- 1} {U}^{H} Y .$$

On the basis of the above steps, the original mathematical equation Y=AF+E may be transformed into: Proj_{A}(Y)=Proj_{A}(AF)+Proj_{A}(E), which is expanded to be expressed as:

$${U ( {U}^{H} U )}^{- 1} {U}^{H} Y = {U ( {U}^{H} U )}^{- 1} {U}^{H} AF + {U ( {U}^{H} U )}^{- 1} {U}^{H} E = AF + {U ( {U}^{H} U )}^{- 1} {U}^{H} E .$$

By making y=U(U^{H}U)⁻¹U^{H}Y and e=U(U^{H}U)⁻¹U^{H}E, the original mathematical equation Y=AF+E may be expressed as y=AF+e. Since ∥U(U^{H}U)⁻¹U^{H}E∥≤∥E∥, it is indicated that after projection, errors caused by noise and the like may be effectively suppressed, and the accuracy of solving of the equation may be further improved.

Since F has sparsity, the above mathematical equation has a unique solution, and the above equation may be transformed into a minimum l₀ norm optimization problem: min∥F∥₀, s.t.∥y−AF∥<<e. Since the above problem belongs to the NP-hard non-convex combinatorial optimization problem, the above problem may be solved by using an adaptive sparsity matching tracking algorithm described below.

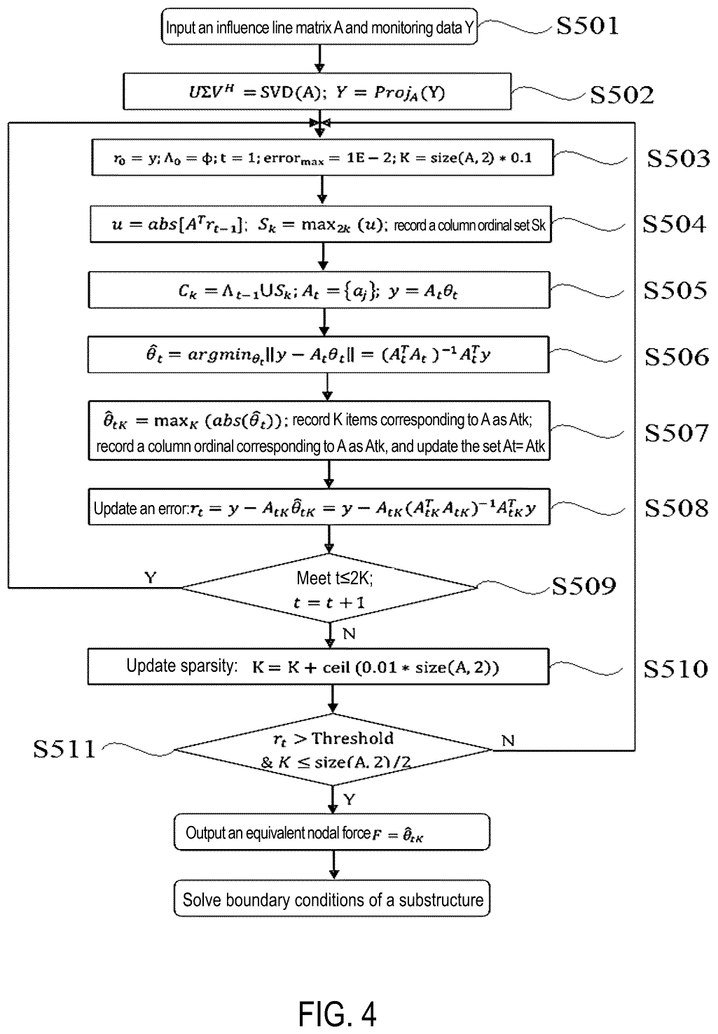

Step S5, as shown in FIG. 4, the above mathematical equation is solved on the basis of the adaptive sparsity matching tracking algorithm provided by the present invention, so as to achieve a high-precision solution of a boundary conditions of the focus region (i.e., boundary conditions of the substructure in FIG. 1). The algorithm includes the following steps:
Step S501, inputting the influence line matrix A and the monitoring data Y;
Step S502, performing singular value decomposition on the influence line matrix, and project Y onto the subspace spanned by the column vectors of the matrix A, i.e., y=Proj_{A}(Y);
Step S503, initializing r₀=y, Λ₀=ϕ, t=1, errorₘₐₓ=1E−2, and K=size (A, 2)*0.1;
Step S504, calculating a correlation coefficient u=abs [A^{T}rₜ₋₁], select 2K maximum values in u, and form a set J₀ (a column ordinal set) by the maximum values corresponding to a column ordinal j of A;
Step S505, enabling Λₜ=Λₜ₋₁∪J₀ and Aₜ=Aₜ₋₁∪aⱼ(j∈J₀);
Step S506, solving y=Aₜθₜ+, that is, \hat{θ}ₜ=argmin_{θ}_{ₜ}∥y−Aₜθₜ∥=(Aₜ^{T}Aₜ)⁻¹Aₜ^{T}y;
Step S507, \hat{θ}_{tK}=max_{K}(abs(\hat{θ}ₜ)), denoting K items corresponding to Aₜ as A_{tK}, denote a column ordinal corresponding to A as Λ_{tK}, and update a set Λₜ=Λ_{tK};
Step S508, calculating and update an error: rₜ=y−A_{tK}\hat{θ}_{tK}=y−A_{tK}(A_{tK}^{T}A_{tK})⁻¹A_{tK}^{T}y;
Step S509, t=t+1, if t≤2K, returning to step S503 to continue an iteration;
Step S510, when a condition t≤2K is not met, updating the sparsity K=K+ceil(0.02*size(A, 2)), where size (A, 2) denotes the number of columns in the matrix A.
Step S511, if the sparsity exceeds K=size (A,2)*0.5 or the error is less than a threshold, proceeding to step S6, otherwise, returning to step S503.

In the formulas, t denotes the number of iterations, Ø denotes an empty set, J₀ denotes an index found in each iteration, ∧ₜ denotes an index set (with the number of elements being Lₜ) of a t-th iteration, aⱼ denotes a j-th column of the influence line matrix A, Aₜ={aⱼ}(j∈∧ₜ) denotes a column set of the influence line matrix A selected according to the index set ∧ₜ, θₜ denotes a column vector of Lₜ×1, and a notation U denotes a set and operation.

Conventional matching tracking algorithms need to know the sparsity of an term to be solved in advance, however, in practical applications, the sparsity is generally difficult to know and needs to be estimated. If the value of K is underestimated, the capacity of accurate solving of the algorithm may be reduced or even eliminated, resulting in the algorithm no longer converging. If the value of K is overestimated, both the robustness and the solving accuracy of the algorithm may be reduced, causing a solving error to be increased. To address the problems, this embodiment provides an adaptive sparsity method, which iteratively changes the sparsity of the term to be solved, so that the sparsity with the highest solving accuracy over multiple iterations is used as the sparsity of the term to be solved, thereby effectively avoiding the problem that the sparsity needs to be known in advance, and achieving an accurate solution of the mathematical equation.

Step S6, in finite element analysis software, a twin substructure finite element model corresponding to the focus region is established by using a solid unit with higher accuracy, and division is performed to obtain more refined finite unit meshes according to the actual analysis needs.

Step S7, a second level of fusion of the inspection and monitoring data of the focus region and the finite element model is performed. Specifically, a reduction relationship between structural deterioration constitution and inspection data such as structural external crack width and internal steel reinforcement corrosion rate is established; construction of a twin substructure is achieved by means of a crack avianized element method and steel reinforcement corrosion deterioration constitution by considering existing structural diseases of the focus region such as cracks and corrosion, and preliminary calculation of the substructure is carried out on the basis of the boundary conditions obtained from the solution in step S5; on this basis, based on the densely distributed strain, displacement and other types of monitoring data in the focus region, the material properties of the focus region are corrected using a model updating method, and substructure refined modeling considering cracks and corrosion is achieved. This step corresponds to the construction of the reduction relationship based on local measured data in FIG. 1 for intelligent crack detection. This step includes the following substeps.

Step S71, a reduction relationship between the structural deterioration constitution and inspection data such as the structural internal steel reinforcement corrosion rate is established, and according to the steel reinforcement corrosion deterioration constitution and the inspection data such as the corrosion rate, material parameters of internal steel reinforcement of the structure, such as interfacial area, yield strength, tensile strength, and the modulus of elasticity are reduced, so as to take into account the influence of the internal steel reinforcement on the structure.

Step S72, a reduction relationship between stiffness of an avianized element and the inspection data such as the structural external crack width is established, a reduction coefficient of the avianized element is inversely deduced according to the specification and the crack width, and a crack is simulated by the avianized element method at the crack. It is worth noting that the CDP model is still used to simulate the plastic behavior of concrete beams, the avianized material properties are used for Young's modulus and tensile strength in the crack region, while the concrete compressive strength remains unchanged. The reduction relationship refers to the material properties of the structure, the material constitution, and material constitutive parameters that need to be input for finite element calculation.

Step S73, on this basis, material properties of the focus region are corrected by using an existing model updating method on the basis of the densely distributed strain, displacement and other types of monitoring data of the focus region.

The substructure model updating method provided in this embodiment may meet various structural analyses. This method fully considers measured data such as a structural corrosion rate and a crack width, and achieves updating of material parameters of structural diseases by fusion with structural deterioration mechanical models.

Step S8, on the basis of the above steps, refined analysis of the structural mechanical state of the focus region is achieved by establishing, for the focus region, the twin substructure finite element model that considers the structural deterioration influence.

Step S9, a boundary node reaction force and material properties of the focus region are acquired by means of the refined twin substructure finite element model, and the boundary reaction force and the material properties are transmitted back to the main structure.

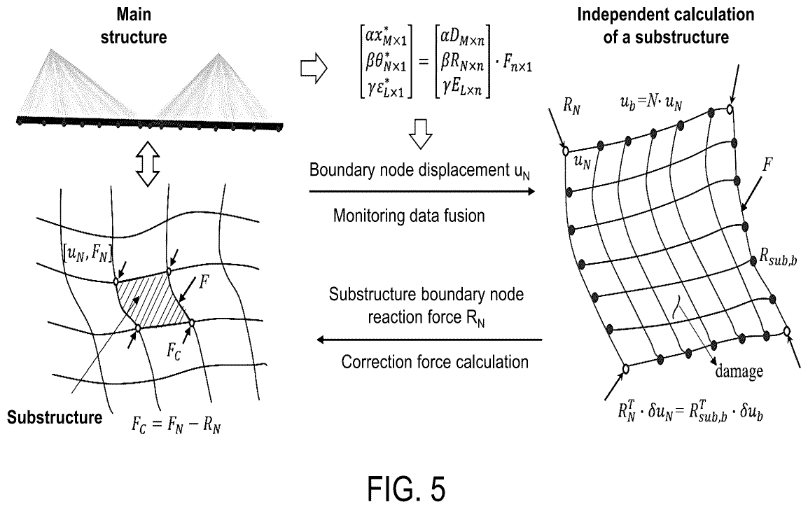

As shown in FIG. 5, the interaction analysis between the substructure and the main structure is performed in steps S9-S10.

Step S10, a correction force is calculated, and the correction force is used as an equivalent external load to act on corresponding nodes of the main structure, so as to complete displacement coordination between the main structure and the substructure, the interaction between the refined twin substructure finite element model and the global model is completed, and equivalent linear elastic analysis of the main structure (corresponding to the global finite element model) is achieved.

The theoretical derivation process of steps S9-S10 is as follows:

For an element integration region of the structure, the following may be obtained from the principle of virtual work:

$${\int }_{{Ω}_{e}} δ {ε}^{T} σ d Ω = {\int }_{S} δ {u}^{T} tds + {\int }_{{Ω}_{e}} δ {u}^{T} bd Ω ,$$

where σ denotes a Cauchy stress tensor, ε denotes a Green strain tensor, b denotes a volume force, ρ denotes a material density, η denotes a damping coefficient, u denotes displacement, Ωₑ denotes the element integration domain, S denotes a boundary of the element integration domain Ωₑ, and t denotes a boundary force.

By adding ∫_{Ω}_{ₑ}δε:Dₑ:εdΩ (Dₑ denotes material stiffness) to both sides of the above equation, the following is obtained:

$${\int }_{{Ω}_{e}} δε : {D}_{e} : ε d Ω = {\int }_{S} δ {u}^{T} tds + {\int }_{{Ω}_{e}} ( δ {u}^{T} b + δ ε : {D}_{e} : ε - {δε}^{T} σ ) d Ω .$$

Under local coordinates, the relationship between the displacement of any point in an element and the displacement of an element node is expressed as: u=Nₑvₑ, and the relationship between the strain and the displacement of the element node is E=Bₑvₑ, where u denotes the displacement of any point in the element, Nₑ denotes a shape function, vₑ denotes the displacement in the local coordinates, ε denotes the strain of any point in the element, and Bₑ denotes a strain matrix.

Thus, an equivalent equation of motion of the element in global coordinates may be obtained:

$$\begin{matrix}{k}_{e} {u}_{e} = {f}_{e} + {f}_{e}^{c} , \\ {f}_{e}^{c} = {k}_{e} {u}_{e} - {r}_{e} ,\end{matrix}$$

where uₑ, \dot{u}ₑ, and üₑ denote the node displacement, velocity and acceleration, respectively, and mₑ, cₑ, kₑ, fₑ^{c}, fₑ^{c}, and rₑ denote the mass matrix, damping matrix, initial stiffness matrix, external force, nonlinear correction force and internal force of the element, which are specifically as follows: mₑ=∫_{Ω}_{ₑ}Nₑ^{T}ρNₑdΩ, cₑ=∫N_{Ω}_{ₑ}^{T}ηNₑdΩ), kₑ=∫_{Ω}_{ₑ}Bₑ^{T}DₑBₑdΩ, fₑ=∫_{Ω}_{ₑ}Nₑ^{T}bₑdΩ+∫_{S}Nₑ^{T}tds, and rₑ=∫_{Ωe}Bₑ^{T}σₑdΩ.

By integrating the equivalent equations of motion of all elements, a control equation for equivalent linear elastic analysis of the overall structure in the global coordinates may be obtained:

$$\begin{matrix}{K}_{0} U = F + {F}^{c} , \\ {F}^{c} = {T}_{s}^{T} {F}_{s}^{c} = {[ {T}_{i}^{T} … {T}_{j}^{T} … {T}_{{N}_{s}}^{T} ] [ {f}_{i}^{cT} … {f}_{j}^{cT} … {f}_{{N}_{s}}^{cT} ]}^{T} ,\end{matrix}$$

where U denotes the node displacement of the structure, K₀ and F respectively denote the stiffness matrix and an external force of the structure, Nₑ denotes the number of all elements of the structure, and Nₛ denotes the number of nonlinear elements. Specific expressions may be as follows: K₀=Σₑ₌₁^{N}^{ₑ}Tₑ^{T}kₑTₑ and F=Σₑ₌₁^{N}^{ₑ}Tₑ^{T}fₑ.

The solution of this embodiment is illustrated below by constructing a test scenario.

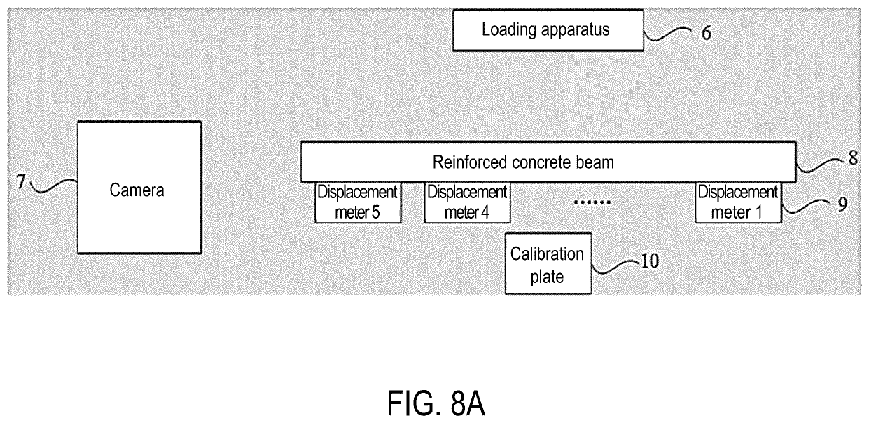

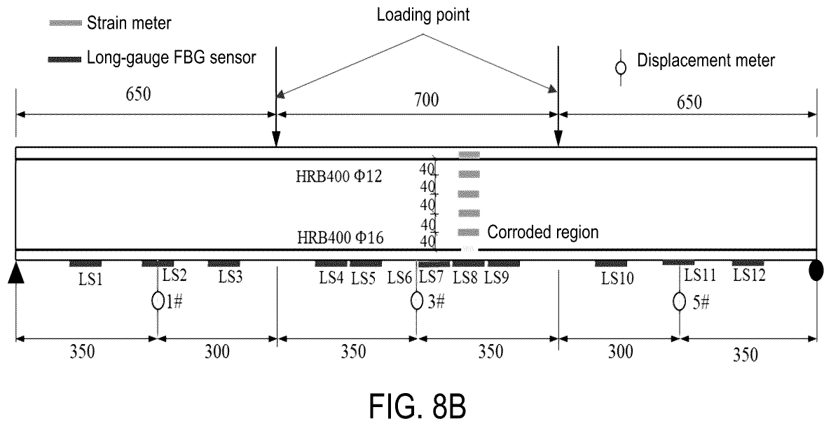

As shown in FIG. 8, an MTS hydraulic loading device was used to carry out a four-point bending test on a crack and corrosion-coupled reinforced concrete beam. In the test, pure bending deformation of a midspan is ensured by means of two-point loading, and the bending capacity of the beam is evaluated by fusion of the inspection and monitoring data. The experimental loading process was performed using load control, crack development was recorded every 5 kN, and at the same time, data of long-gauge fiber optic sensors, strain meters, and displacement meters was recorded. (a) is a schematic structural diagram of scenario building, and (b) is a schematic cross-sectional view of the reinforced concrete beam.

The sensor arrangement abides by the idea of regional distribution, that is, sensors are densely arranged in the focus portion, while few sensors are arranged on non-focus portions. The sensor arrangement is shown in FIG. 8, where there are 12 long-gauge fiber optic sensors, i.e., LS1-LS12 in the figure. In order to monitor the deformation of the reinforced concrete beam, five displacement meters were arranged at the bottom of the beam, i.e., 1#-5 #displacement meters in the figure. In order to focus on monitoring the performance of a corroded element, five strain meters were arranged on one side of the beam with a spacing of 40 cm. An industrial camera was mainly used to record the crack development of the reinforced concrete beam.

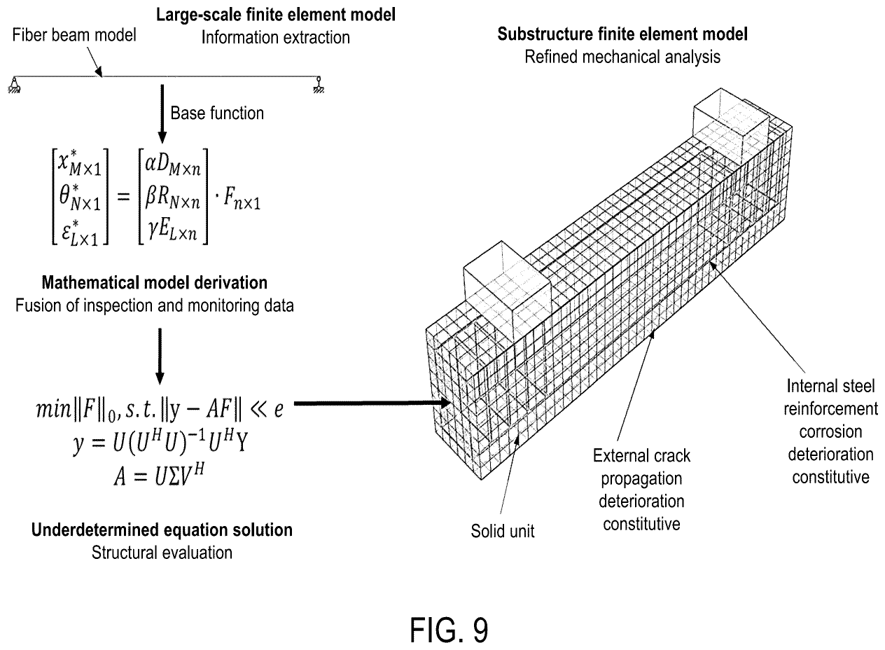

As shown in FIG. 9, according to the structural focus region refined analysis method for the two-level fusion of the inspection and monitoring data and the finite element model disclosed in the present invention, the following operations are successively carried out on the reinforced concrete structure in Embodiment 1: (1) according to an inspection result of the reinforced concrete beam, a structure to be analyzed thereof is divided into a focus region (substructure) and a plurality of non-focus regions; (2) the multivariate monitoring data and the finite element influence line information of the focus region and the non-focus regions are extracted, respectively; (3) the mathematical equation of the small amount of monitoring data and the finite element influence line information of the non-focus regions is established; (4) on the basis of mathematical equation derivation, the above mathematical equation is transformed into the NP-hard non-convex combinatorial optimization problem; (5) the above mathematical equation is solved on the basis of the adaptive sparsity matching tracking algorithm provided by this embodiment, so as to achieve the high-accuracy solution of the boundary conditions of the focus region; (6) the refined finite element model of the focus region is established by using the solid unit with higher accuracy, and division is performed to obtain more refined finite element meshes according to the actual analysis needs; (7) the reduction relationship between the structural deterioration constitution and the inspection data such as the structural external crack width and the internal steel reinforcement corrosion rate is established, the twin substructure is established by means of the crack avianized element method and the steel reinforcement corrosion deterioration constitution by considering existing structural diseases of the focus region such as cracks and corrosion, and on this basis, the material properties of the focus region are updated using the model updating method on the basis of the densely distributed strain, displacement and other types of monitoring data of the focus region; and (8) on the basis of the above steps, the refined analysis of the structural mechanical state of the focus region is achieved.

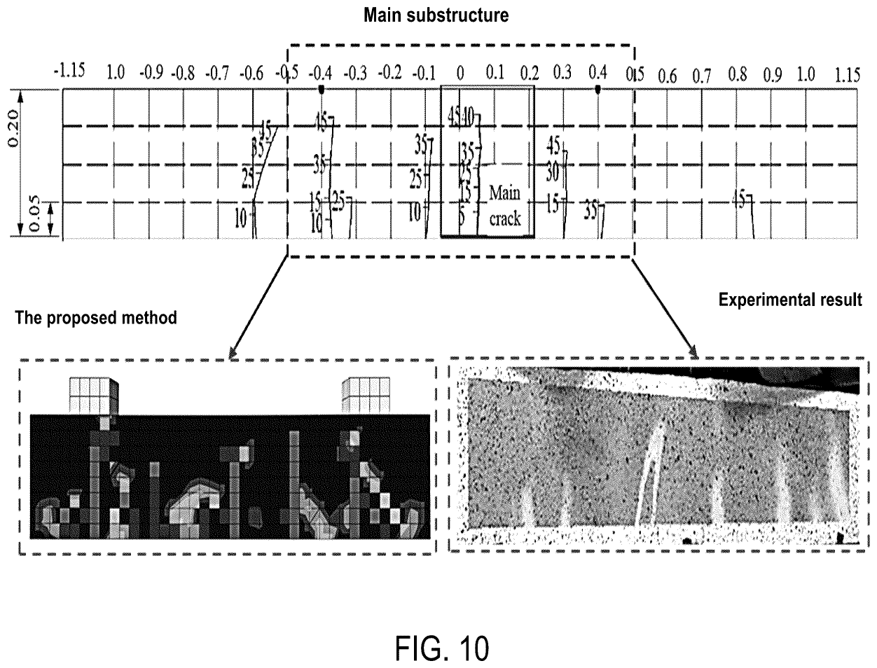

As shown in FIG. 10, the focus region finite element model established by the method of the present invention has high accuracy, and analysis results of the focus region are basically consistent with the test structure. In addition, the crack distribution of the focus region finite element model is basically consistent with the test distribution. Cracks are mainly distributed in the midspan portion, and obvious main cracks appear near the corrosion, where the element stiffness and bearing capacity are obviously reduced.

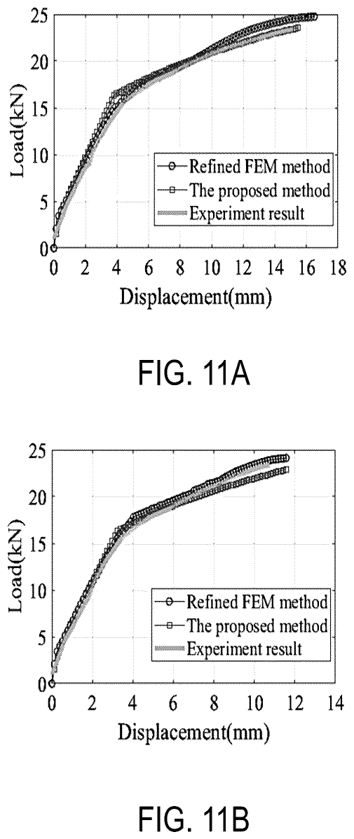

According to the method described above, interaction analysis results of the main structure are shown in FIG. 11. Load-displacement curves of the nonlinear analysis of the substructure and the equivalent linear elastic analysis of the main structure disclosed in this embodiment are basically consistent with measured load-displacement curves and load-displacement curves of the refined finite element model, which verifies the accuracy of results of the bearing capacity evaluation of concrete beams by the method proposed herein. In terms of analysis efficiency, it takes 15 min and 53 sec for the global refined finite element model to complete one analysis, while it takes 9 min and 03 sec for the substructure interaction analysis method proposed herein to carry out one calculation, which greatly improves the analysis and evaluation efficiency.

The method has the following advantages.

(1) In order to solve the bottleneck problem that the inspection and monitoring data and the finite element model are difficult to integrate, through establishment of the mathematical equation of the intrinsic connection between the non-focus regions and the influence line model of the finite element model, focus region finite element model lifting considering the internal corrosion and the external cracks, and the two-level fusion of the inspection and monitoring data and the finite element model, the modeling and analysis accuracy of the finite element model of the structural focus region is improved. Through the fusion of the inspection and monitoring data, the analysis accuracy of the structural focus region is improved by 10% or more.

(2) In order to solve the problem that for some structures, it is difficult to arrange sensors on the boundary of the focus region to measure boundary physical condition values thereof, the present invention establishes the mathematical equation of the intrinsic connection between the monitoring data of the non-focus regions and the finite element influence line, and achieves the high-accuracy solution of the boundary conditions the focus region by means of the adaptive sparsity matching tracking algorithm. The method can effectively solve the boundary conditions of the focus region only with a small amount of monitoring data of the non-focus regions, thereby solving the problem that it is difficult to arrange sensors on the boundary of a complex structure and the boundary cannot be measured.

(3) In order to solve the problem of low efficiency caused by establishing an overall refined finite element model for a structure with large size and complex stress state to carry out structural analysis, the present invention innovatively proposes the interaction analysis method of the refined analysis of the focus region and the equivalent linear elastic analysis of the main structure, and transforms the time-consuming analysis of establishing a refined model globally considering damages of the overall structure into the nonlinear analysis of the focus region and the equivalent linear elastic analysis of the simplified main structure. The method eliminates the need for the establishment of a refined model of the entire structure, can complete structural analysis and evaluation by means of the interaction analysis of the focus region and the main structure, has the advantages of fast and accurate analysis, and improves the efficiency by 15% or more.

### Embodiment 2

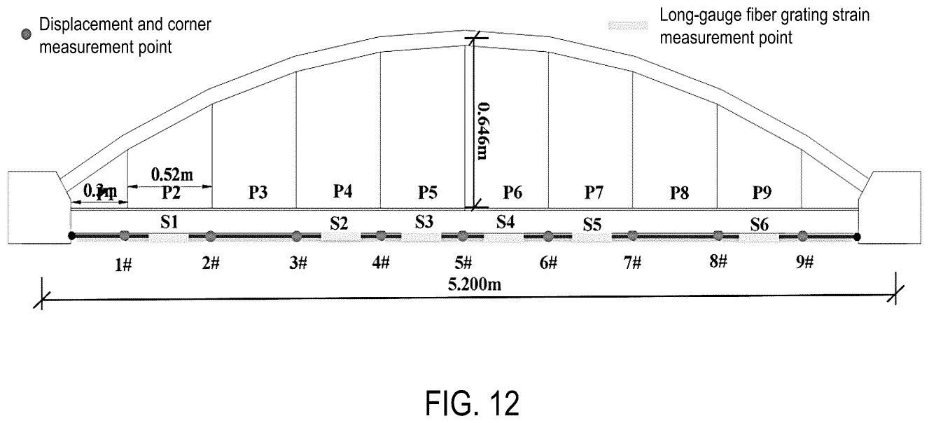

In order to further verify the feasibility of the method in steel structures, a scale model of a tied steel arch bridge is used herein to carry out the experimental study. As shown in FIG. 12, the total length of the arch bridge is about 5.2 m, the width of the bridge is about 0.875 m, and the height is about 0.646 m. The arch bridge is mainly made of Q235 steel, and mainly includes tie beams, cross beams, arch ribs, supports and other components. The tie beams have an H-shaped section of 125*125*6.5*9, the cross beams have an H-shaped section of 100*100*6*8, and the arch ribs have a cross section of Ø50×4. The distribution of strain sensors mainly adopts a regional distribution method, that is, sensors are densely arranged in the focus region in the midspan, while relatively few sensors are arranged in other portions. The strain sensors adopt long-gauge fiber optic sensors, with a gauge length of 0.26 m. Nine displacement and corner measurement points are arranged at nodes of the cross beams. A loading apparatus is provided between cross beams P4 and P7 for loading, and four levels of loads are set up in total, which are respectively: 20 kN, 40 kN, 52 kN and 63 kN.

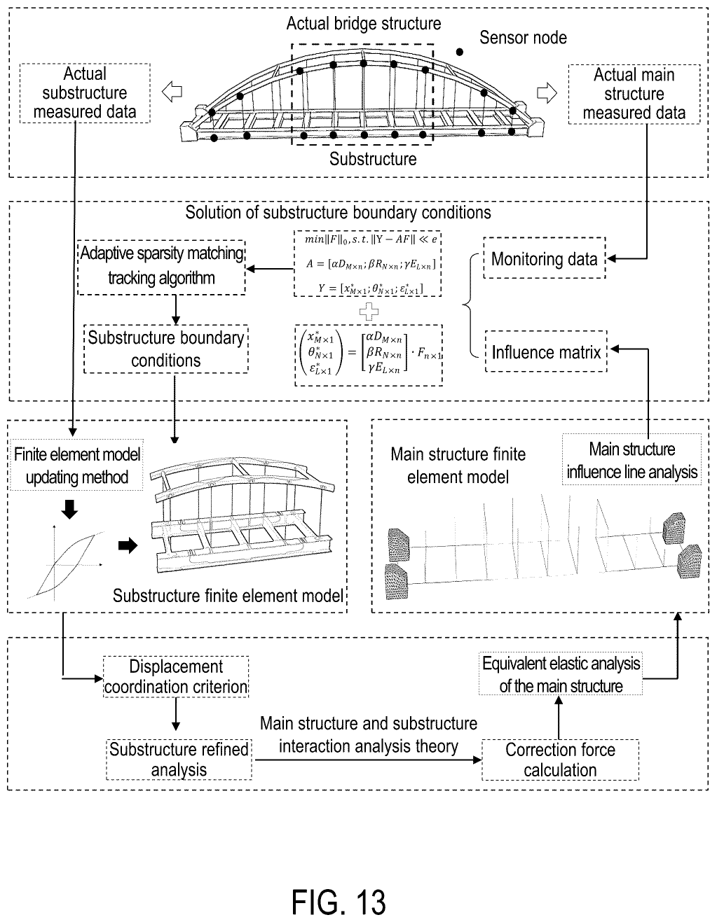

As shown in FIG. 13, on the basis of the targeted perception-oriented twin substructure interaction method described above, the following steps are performed: (1) establish a mathematical model of bridge monitoring data and mechanical information of the large-scale finite element model; (2) fuse singular value decomposition (SVD) and adaptive sparsity to propose a new compressed sampling matching tracking algorithm to accurately solve the underdetermined equation, so as to achieve a high-accuracy solution of structural boundary displacements; (3) by combining large-scale finite element simulation with structural stress analysis characteristics and structural inspection results, select a structural focus region, establish a refined substructure model by using a solid unit, and carry out independent analysis on the refined substructure model on the basis of the above solved boundary conditions; and (4) transform the boundary reaction force of the substructure into the equivalent external load of the main structure, and carry out equivalent linear elastic analysis on the main structure, so as to achieve interaction analysis of the substructure and the main structure. Finally, information transfer between the inspection and monitoring data and the finite element model as well as between the overall large-scale model and the local refined model is achieved.

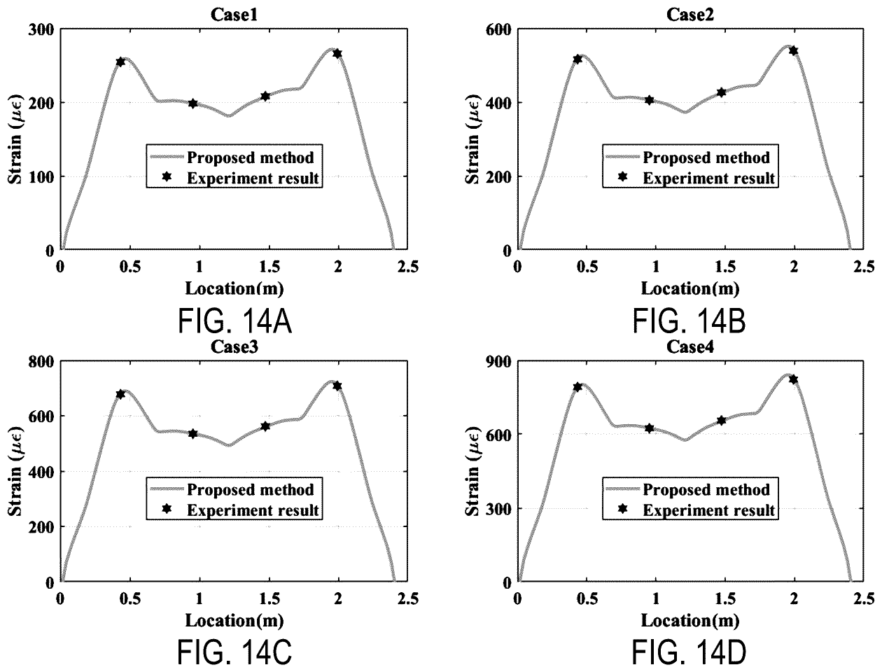

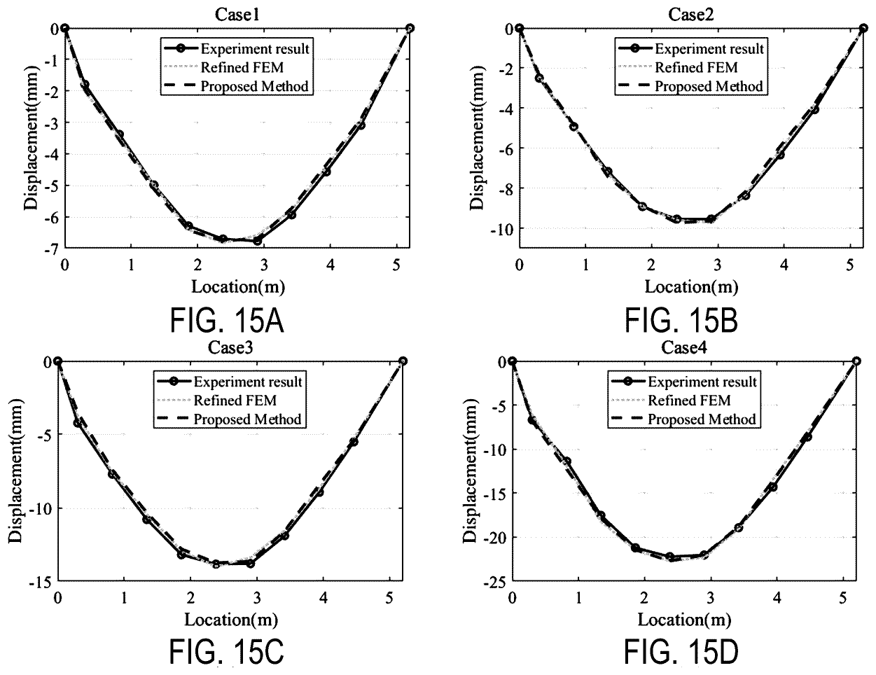

As shown in FIG. 14, the stress state of the substructure may be effectively analyzed on the basis of the method provided herein, and strains under four different loading conditions are in good agreement with experimental results. As shown in FIG. 15, according to the numerical substructure theory, the boundary force of the substructure is transformed into the equivalent external load of the main structure, the equivalent linear elastic analysis is carried out on the main structure, global analysis is performed on the basis of the updated main structure finite element model to obtain a displacement response curve thereof, and a load-displacement curve based on the large-scale finite element model is basically the same as a measured load-displacement curve. In the case of the maximum load (63 kN) of the bridge structure, a measured displacement value of the bridge is less than a theoretically calculated displacement value, a structural checkout coefficient η<1, the structural bearing capacity meets the requirements, and the structure is safe. This embodiment further validates the effectiveness of the proposed method in the field of steel structures.

The present invention adopts the concept of “targeted perception”, that is, a focus region is obtained through division in a targeted manner according to the characteristics of an existing structural health monitoring system to form the numerical substructure, so that a more refined solid unit is used to construct the twin substructure finite element model, thereby achieving “secondary analysis”. In the process of “secondary analysis”, on the one hand, a corresponding structural damage mechanism may be introduced for specific diseases to achieve focused analysis of the focus region. On the other hand, the monitoring data of the focus region may be fully utilized, and the monitoring data may be fully integrated with the finite element model through mathematical equations, model enhancement and other methods, so as to achieve refined analysis of the mechanical performance of the substructure of the focus region.

### Embodiment 3

Compared to Embodiment 1 or Embodiment 2, a main structure in this embodiment is free of disease, so that material properties of a substructure are updated only on the basis of step S73. The method has good practicality and is suitable for model updating for various structures such as concrete and steel structures.

### Embodiment 4

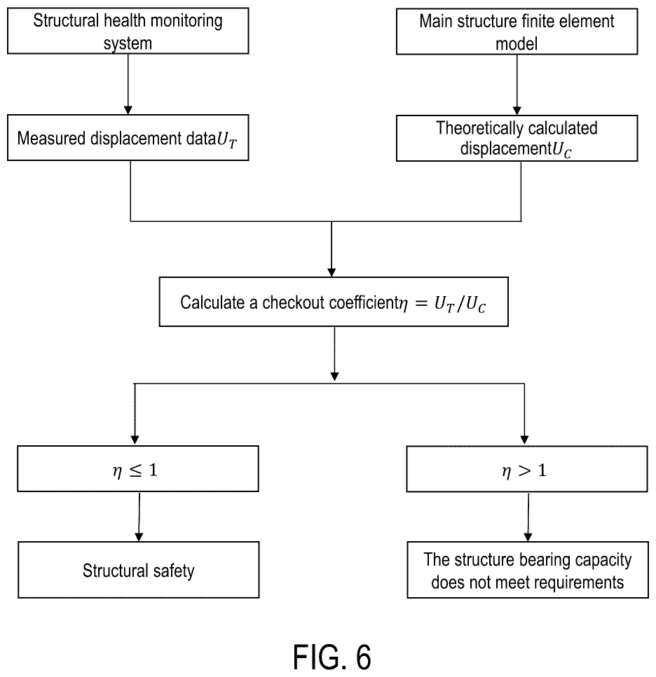

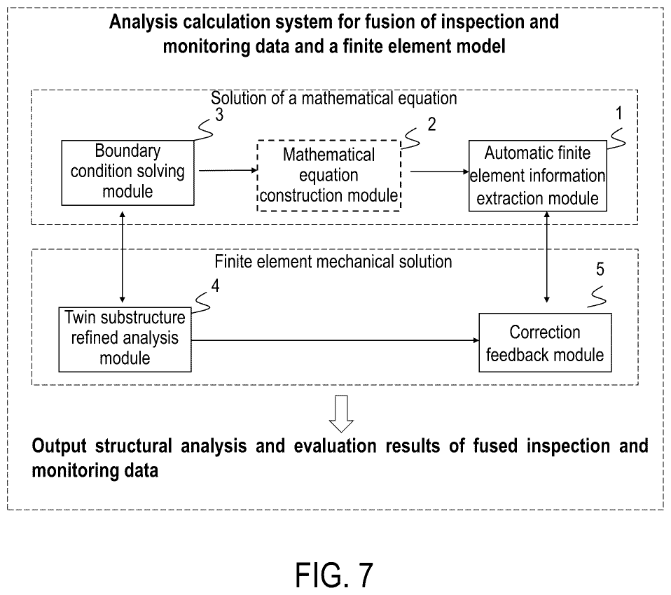

On the basis of the foregoing embodiments, this embodiment provides a method for achieving bearing capacity safety evaluation by utilizing the foregoing targeted perception-oriented twin substructure interaction method. By means of the interaction analysis method of the substructure and the main structure in the foregoing embodiment, inspection and monitoring data information is indirectly fused into the main structure through the interaction between the substructure and the main structure. By carrying out structural safety evaluation on the basis of the established main structure finite element model, both accuracy and efficiency are achieved. As shown in FIG. 6, the analysis and evaluation method based on the main structure finite element model is specifically reflected in the following: a theoretical calculated displacement U_{C} is obtained through the main structure finite element model, a measured displacement U_{T} is obtained through an actual structural health monitoring system, the theoretical calculated displacement U_{C} and the measured displacement U_{T} are combined to calculate a check coefficient

$$η = \frac{{U}_{C}}{{U}_{C}} ,$$

and the structural safety evaluation is carried out according to the check coefficient. If the calibration coefficient meets η≤1, it is determined that the structure is in safe operation; and if the calibration coefficient meets η>1, it is determined that the structural bearing capacity does not meet the requirements.

### Embodiment 5

Referring to FIG. 1, this embodiment provides a targeted perception-oriented twin substructure interaction system in order to achieve analysis calculation for fusion of inspection and monitoring data and a finite element model. The system includes:
an automatic finite element information extraction module configured to carry out influence line analysis on a simplified finite element model, the module mainly having the functions of batch modification of node loads, batch submission of jobs, and batch extraction of displacement, strain, corner and other influence line information, which helps to improve the extraction efficiency of finite element information and achieve automatic extraction of multivariate monitoring data and finite element influence line information;
a mathematical equation construction module configured to construct a mathematical equation of the intrinsic connection among monitoring data, finite mechanical information and node loads, and configured to solve the above mathematical equation and obtain boundary conditions of an important region (substructure), the module integrating singular value analysis, subspace projection and an adaptive sparsity matching tracking algorithm, thereby achieving an accurate solution of physical boundaries of the substructure of the important region to be analyzed;
a boundary condition solving module configured to construct the mathematical equation of the intrinsic connection among the monitoring data, the finite mechanical information and the node loads, the module having the functions of automatic data reading, automatic construction of complete equations, automatic construction of underdetermined equations, etc., thereby achieving a first level of fusion of monitoring data of non-focus regions and the finite element model;
a twin substructure refined identification module configured to establish a more accurate solid unit model for the focus region and consider common structural diseases such as cracks and corrosion, the module having the functions of modeling of the refined solid unit, considering of crack and corrosion disease, updating of the substructure finite element model, etc., thereby achieving refined identification of the focus region; and
a correction feedback module configured to acquire a boundary node reaction force and material properties of the focus region, and transmit the boundary reaction force and the material properties back to the main structure, the module having the functions of automatic acquisition of the node reaction force and the material properties, automatic calculation of a correction force, real-time data transmission, etc., using the correction force as an equivalent external load to act on corresponding nodes of the main structure, and achieving secondary analysis of the main structure.

The above modules are organically integrated with the aforementioned targeted perception-oriented twin substructure interaction method, have a high degree of automation, and may quickly and efficiently achieve bridge analysis and evaluation based on fusion of the inspection and monitoring data.

### Embodiment 6

This embodiment provides an electronic device. The electronic device includes: one or more processors and a memory, the memory storing at least one program, and the program including instructions for performing the targeted perception-oriented twin substructure interaction method according to the preceding embodiment.

### Embodiment 7

This embodiment provides a computer-readable storage medium. The computer-readable storage medium includes at least one program for execution by at least one processor of an electronic device, and the program includes instructions for performing the targeted perception-oriented twin substructure interaction method according to the preceding embodiment.

The above description is merely specific implementations of the present invention, and is not intended to limit the scope of protection of the present invention. All equivalent modifications or substitutions which may be easily conceived by those skilled in the art within the technical scope disclosed by the present invention shall fall within the scope of protection of the present invention. Accordingly, the scope of protection of the present invention shall be as set forth in the claims.

To the claims:

1. A targeted perception-oriented twin substructure interaction method, characterized by comprising the following steps:
acquiring multivariate inspection and monitoring data and finite element influence line data of a main structure, wherein the main structure is divided into a focus region and a non-focus region;
solving, on the basis of the inspection and monitoring data and the finite element influence line data of the non-focus region, boundary conditions of the focus region using an adaptive sparsity matching tracking algorithm to achieve a first level of data fusion;
establishing, for the focus region, a refined twin substructure finite element model considering a structural deterioration influence, and correcting material properties of the refined twin substructure finite element model on the basis of the inspection and monitoring data and the finite element influence line data of the focus region to achieve a second level of data fusion; and
calculating a correction force on the basis of the boundary conditions of the focus region and the material properties, and using the correction force as an equivalent external load to act on nodes of a global finite element model, to complete interaction between the refined twin substructure finite element model and the global finite element model.

2. The targeted perception-oriented twin substructure interaction method according to claim 1, wherein the process of solving the boundary conditions of the focus region comprises:
establishing a mathematical equation for the monitoring data and the finite element influence line data of the non-focus region; and
transforming the mathematical equation into an NP-hard non-convex combinational optimization problem to be solved using the adaptive sparsity matching tracking algorithm.

3. The targeted perception-oriented twin substructure interaction method according to claim 1, wherein the adaptive sparsity matching tracking algorithm comprises following steps:
constructing an influence line matrix on the basis of the finite element influence line data, performing singular value decomposition, and projecting the multivariate inspection and monitoring data onto a subspace spanned by column vectors of the influence line matrix; and
on the basis of projection of the multivariate inspection and monitoring data onto the subspace spanned by the column vectors of the influence line matrix, changing sparsity of an item to be solved by iterative computation, and taking sparsity with the highest solving accuracy after repeated iterations as the sparsity of the item to be solved.

4. The targeted perception-oriented twin substructure interaction method according to claim 3, wherein the adaptive sparsity matching tracking algorithm specifically comprises:
Step 1, inputting the influence line matrix A and the monitoring data Y;
Step 2, performing singular value decomposition on the influence line matrix, and projecting the monitoring data Y onto the subspace spanned by the column vectors of the influence line matrix A, i.e., y=Proj_{A}(Y);
Step 3, initializing r₀=y, Λ₀=ϕ, and t=1;
Step 4, calculating a correlation coefficient u=abs[A^{T}rₜ₋₁], selecting 2K maximum values in u, and forming a column ordinal set J₀ by the maximum values corresponding to a column ordinal j of A;
Step 5, enabling Λₜ=Λₜ₋₁∪J₀ and Aₜ=Aₜ₋₁∪aⱼ(j∈J₀);
Step 6, calculating \hat{θ}ₜ=argmin_{θ}_{ₜ}∥y−Aₜθₜ∥=(Aₜ^{T}Aₜ)⁻¹Aₜ^{T}y;
Step 7, \hat{θ}_{tK}=max_{K}(abs(\hat{θ}ₜ)), denoting K items corresponding to Aₜ as A_{tK}, denoting a column ordinal corresponding to A as Λ_{tK}, and updating a set Λₜ=Λ_{tK};
Step 8, calculating and updating an error rₜ=y−A_{tK}θ_{tK}=y−A_{tK}(A_{tK}A_{tK})⁻¹A_{tK}^{T}y;
Step 9, t=t+1, if t≤2K, returning to Step 2 to continue an iteration, otherwise, proceeding to Step 10;
Step 10, updating the sparsity K=K+ceil(0.02*size(A, 2)); and
Step 11, if the sparsity exceeds K=size(A,2)*0.5 or the error is less than a preset threshold, outputting an equivalent node force F=\hat{θ}_{tK} as the boundary conditions of the focus region, otherwise, performing Step 4,
wherein t denotes the number of iterations, Ø denotes an empty set, J₀ denotes an index obtained from each iteration, ∧ₜ denotes an index set of a t-th iteration, the number of elements of ∧ₜ is Lₜ, aⱼ denotes a j-th column of the influence line matrix A, Aₜ={aⱼ}(j∈∧ₜ) denotes a column set of the influence line matrix A selected according to the index set ∧ₜ, θₜ denotes a column vector of Lₜ×1, and a notation U denotes a set and operation.

5. The targeted perception-oriented twin substructure interaction method according to claim 1, wherein the structural deterioration influence comprises an external crack disease influence and an internal corrosion disease influence.

6. The targeted perception-oriented twin substructure interaction method according to claim 5, wherein process of constructing the refined twin substructure finite element model considering the structural deterioration influence comprises:
establishing a first reduction relationship between an external crack width of the main structure and stiffness of an avianized element using a crack avianized element method to achieve modeling of the external crack disease influence;
establishing a second reduction relationship between an internal steel reinforcement corrosion rate of the main structure and a structural deterioration constitution on the basis of material parameters inside a steel reinforcement corrosion deterioration constitution to achieve modeling of the internal corrosion disease influence; and
constructing the refined twin substructure finite element model on the basis of the first reduction relationship and the second reduction relationship.

7. The targeted perception-oriented twin substructure interaction method according to claim 1, wherein the focus region is a multi-disease region found during inspection or a vulnerable region of mechanical analysis, and the non-focus region is a portion of the main structure other than the focus region.

8. The targeted perception-oriented twin substructure interaction method according to claim 1, wherein the multivariate inspection and monitoring data comprises a node displacement value, a node corner value and a strain displacement value, and the material properties comprise at least one of a concrete constitutive parameter, a steel reinforcement constitutive parameter, and a steel constitutive parameter.

9. An application method of the targeted perception-oriented twin substructure interaction method according to claim 1, characterized by comprising following steps:
completing interaction between the refined twin substructure finite element model and the global finite element model using the targeted perception-oriented twin substructure interaction method;
calculating a theoretical displacement of a node using the global finite element model subjected to interaction;
acquiring a measured displacement of the node; and
performing a safety evaluation on a load carrying capacity of the main structure on the basis of the theoretical displacement and the measured displacement.

10. A targeted perception-oriented twin substructure interaction system, characterized by comprising:
a finite element information extraction module configured to acquire finite element influence line data;
a mathematical equation construction module configured to construct a mathematical equation of an intrinsic connection among monitoring data, finite mechanical information and a node load;
a boundary condition solving module configured to solve, with respect to the mathematical equation, boundary conditions of a focus region by means of a preset storage medium on the basis of the finite element influence line data of a non-focus region of a main structure and obtained multivariate inspection and monitoring data, wherein the storage medium comprises an instruction for implementing an adaptive sparsity matching tracking algorithm;
a twin substructure refined identification module configured to establish, for the focus region of the main structure, a refined twin substructure finite element model considering a structural deterioration influence; and
a correction feedback module configured to correct material properties of the refined twin substructure finite element model on the basis of the inspection and monitoring data and the finite element influence line data of the focus region, calculate a correction force on the basis of the boundary conditions of the focus region and the material properties, and use the correction force as an equivalent external load to act on nodes of a global finite element model.
